(19) United States
(12) Patent Application Publication
(10) Pub. No.: US 2025/0036709 A1
(43) Pub. Date: Jan. 30, 2025

(54) ADAPTIVE FEATURE SELECTION

(71) Applicant: INTERNATIONAL BUSINESS MACHINES CORPORATION, Armonk, NY (US)

(72) Inventors: Tobia Boschi, Dublin (IE); Jonathan Peter Epperlein, Phibsborough (IE); Gabriele Picco, Dublin (IE); FRANCESCA BONIN, Dublin (IE)

(21) Appl. No.: 18/225,834

(22) Filed: Jul. 25, 2023

(51) Int. Cl. G06F 17/11

(52) U.S. Cl. CPC G06F 17/11

(57) ABSTRACT

Embodiments receive a matrix of a plurality of observations and a plurality of features; Perform feature selection of the matrix of the plurality of observations and the plurality of features by solving an optimizing function; and output a class probability prediction based on estimated coefficient parameter values for selected features based on performing the feature selection of the matrix. In further embodiments, the plurality of features are mixed and include categorical features, functional features, and continuous features.

### BACKGROUND

Aspects of the present invention relate generally to adaptive feature selection and, more particularly, to adaptive feature selection for mixed classification problems.

Functional data includes data measured multiple times over time and space. Functional data is represented by curves defined on a specific domain. Other forms of data may include categorical and continuous data. Categorical, continuous, and functional data may be high-dimensional, in which the number of features is much larger than the number of observations.

### SUMMARY

In a first aspect of the invention, there is a computer-implemented method including: receiving, by a processor set, a matrix of a plurality of observations and a plurality of features; performing, by the processor set, feature selection of the matrix of the plurality of observations and the plurality of features by solving an optimizing function; and outputting, by the processor set, a class probability prediction based on estimated coefficient parameter values for selected features based on performing the feature selection of the matrix. The plurality of features are mixed and includes categorical features, functional features, and continuous features.

In another aspect of the invention, there is a computer program product including one or more computer readable storage media having program instructions collectively stored on the one or more computer readable storage media. The program instructions are executable to: receive a matrix of a plurality of observations and a plurality of features; perform feature selection of the matrix of the plurality of observations and the plurality of features by solving an optimizing function; and output a class probability prediction based on estimated coefficient parameter values for selected features based on performing the feature selection of the matrix. The plurality of features are mixed and include categorical features, functional features, and continuous features.

In another aspect of the invention, there is a system including a processor set, one or more computer readable storage media, and program instructions collectively stored on the one or more computer readable storage media. The program instructions are executable to: receive a matrix of a plurality of observations and a plurality of features; perform feature selection of the matrix of the plurality of observations and the plurality of features by solving an optimizing function; and output a class probability prediction based on estimated coefficient parameter values for selected features based on performing the feature selection of the matrix. The plurality of features are mixed and include categorical features, function features, and continuous features.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of an adaptive feature selection server in accordance with aspects of the present invention.

FIG. 3 shows a flowchart of an exemplary method of the adaptive feature selection server in accordance with aspects of the present invention.

FIG. 4 shows a block diagram of another exemplary environment of the adaptive feature selection server in accordance with aspects of the present invention.

### DETAILED DESCRIPTION

Aspects of the present invention relate generally to adaptive feature selection and, more particularly, to adaptive feature selection for mixed classification problems. Embodiments of the present invention perform adaptive feature selection and classification with mixed data. Embodiments of the present invention receive data from different sources and characterize the data from different sources by a heterogenous structure. Embodiments of the present invention perform feature selection to reduce a problem's dimensionality and detect the most important variables for a specific target. Embodiments of the present invention include a highly computationally efficient method for selecting the most significant features to perform a classification task characterized by a large number of mixed features of data (e.g., categorical, continuous, and functional data). Embodiments of the present invention include a system for jointly solving a classification and feature selection tasks. In particular, the system of the embodiments jointly solves the classification and the feature selection tasks in scenarios in which a number of features are much bigger than a number of observations and the features are mixed multimodal (e.g., the features can be simultaneous functional, continuous, and categorical). In particular, a number of observations correspond with different subjects and a number of features correspond with functional, categorical, and/or categorical data. Embodiments of the present invention output a set of selected features with a feature-specific coefficient. Embodiments of the present invention output a combination of mixed coefficients which allow for predicting a classification probability. In particular, mixed coefficients of the embodiments include scalars for continuous and categorical features and curves and surfaces for functional features. Embodiments of the present invention perform adaptive feature selection for logistic regression and classification. Embodiments of the present invention manage a large number of input mixed features.

Embodiments of the present invention provide adaptive feature selection for mixed data classification in comparison to conventional systems. Conventional systems are not able to adequately handle high-dimensional data in which the number of features is much bigger than the number of observations. In particular, as conventional systems are not able to adequately handle high-dimensional data, conventional systems are not able to optimize a solution for the high-dimensional data. Embodiments of the present invention perform feature selection to reduce the dimensionality of data and detect the most important variables in order to optimize the solution for the high-dimensional data.

Embodiments of the present invention include a highly computationally efficient system, method, and computer program product for selecting the most significant features to perform a classification task for a large number of mixed feature data. Accordingly, implementations of aspects of the present invention provide an improvement (i.e., technical solution) to a problem arising in the technical field of data classification and optimization of mixed data. In particular, embodiments of the present invention perform adaptive feature selection for mixed data classification problems. Embodiments of the present invention also output feature-specific coefficients corresponding to the mixed data. Also, embodiments of the present invention may not be performed in the human mind because aspects of the present invention comprise using machine learning (ML) algorithms, such as an adaptive implementation of feature selection for classification of high-dimensional data. Further, these implementations of the present invention improve the functioning of the computer by reducing the dimensionality of high-dimensional data, detecting the most important variables for the high-dimensional data, and optimizing the solution for the high-dimensional data.

Implementations of the invention are necessarily rooted in computer technology. For example, the step of performing feature selection of a matrix of a plurality of observations and a plurality of features by solving an optimizing function is computer-based and cannot be performed in the human mind. Training and using a machine learning model are, by definition, performed by a computer and cannot practically be performed in the human mind (or with pen and paper) due to the complexity and massive amounts of calculations involved. For example, an adaptive implementation of feature selection for classification of high-dimensional data may perform an iterative process of a path search mechanism and iteratively perform computations to optimize a solution for high-dimensional data. In particular, an adaptive implementation of feature selection for classification of high-dimensional data performs a large amount of processing of data and modeling of parameters across many dimensions to train the model such that the model generates an output in real time (or near real time). Given the scale and complexity of processing data and modeling of parameters across many dimensions, it is simply not possible for the human mind, or for a person using pen and paper, to perform the number of calculations involved in training and/or using a machine learning model.

Aspects of the present invention include a method, system, and computer program product for selecting features from mixed data with a high computational efficiency. For example, a computer-implemented method includes: receiving observation labels and values of each features; and outputting a subset of important features and coefficient parameters to predict the observation labels with estimated probabilities. The computer-implemented method may also include managing high-dimensional scenarios where a number of features is much larger than a number of observations. The computer-implemented method may also include managing a combination of continuous, categorical, and function data, in which function data is defined as curves expressed on a specific domain starting from multiple measurements over time and/or space. The computer-implemented method may also include the coefficient parameters being feature specific, such as scalars for continuous and categorical features and curves and surfaces for functional features.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as adaptive feature selection code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

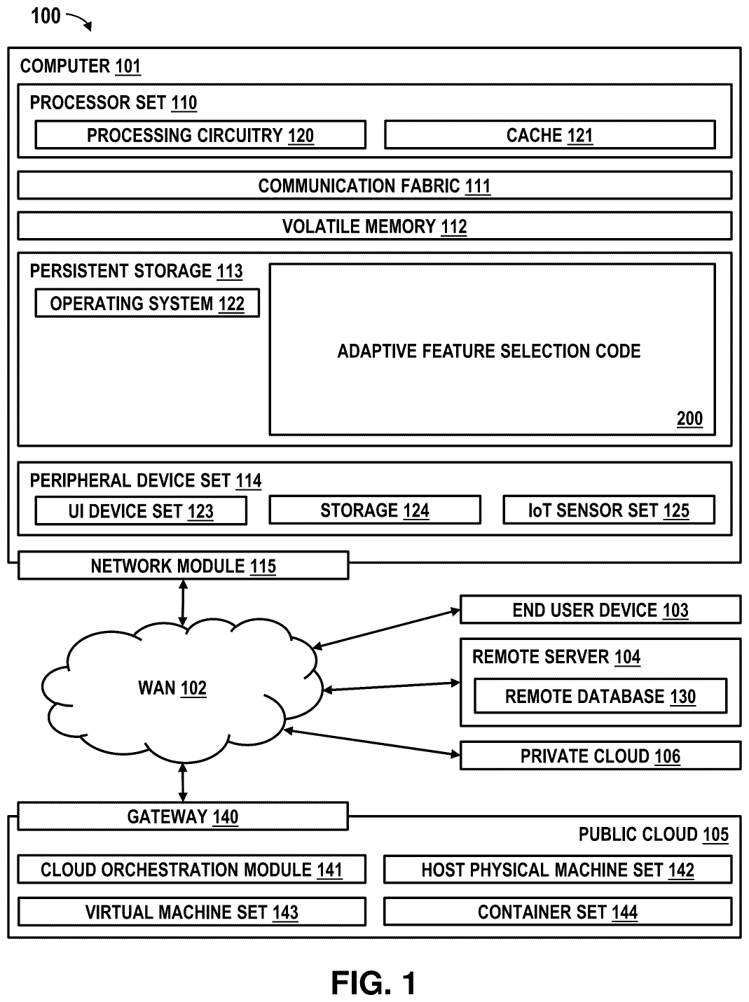

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

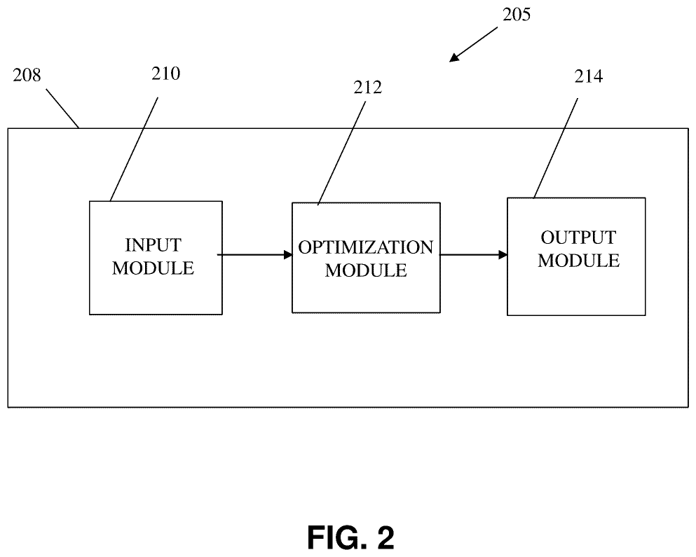

FIG. 2 shows a block diagram of an exemplary environment 205 in accordance with aspects of the present invention. In embodiments, the environment 205 includes the adaptive feature selection server 208, which may comprise one or more instances of the computer 101 of FIG. 1. In other examples, the adaptive feature selection server 208 comprises one or more virtual machines or one or more containers running on one or more instances of the computer 101 of FIG. 1.

In embodiments, the adaptive feature selection server 208 of FIG. 2 comprises an input module 210, an optimization module 212, and an output module 214, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The adaptive feature selection server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the invention, the input module 210 receives a matrix of n observations and p features. In embodiments, n is an integer value which represents the last observation and p is a mixed integer feature value which represents the last mixed feature. In further embodiments, the number p of mixed features is much greater than the number n of observations. For example, the number p of mixed features including a large number of biometric data is far greater than the number n of observations including a small number of patients. In a specific example, the number p of mixed features is at least 100 times greater than the number n of observations. In particular, for each observation, a label is included which describes a class the which the observation corresponds. Each of the mixed features in the matrix of n observations and p features can be a functional feature, a continuous feature, or a categorical feature. The input module 210 sends the matrix of n observations and p features to the optimization module 212.

In embodiments, the optimization module 212 performs feature selection by identifying the most important features for the classification task. In embodiments, the optimization module 212 performs feature selection by identifying the most important features of the classification task improves modeling of the most important features within the context of machine learning (ML) algorithms. In particular, the optimization module 212 performs an optimization function by minimizing an addition of a logistic loss and a penalty as shown below:

$$Optimization function = minimum [ logistic loss + penalty ] ( Optimization function ) .$$

In embodiments, the logistic loss performs classification and predicts probabilities of belonging to a specific class. In embodiments, the penalty performs feature selection and comprises a lasso term to create sparsity, a ridge term to address collinearity and increase the convergence rate of the method, and adaptive weights to improve the selection and the prediction performance. In embodiments, the lasso term performs both variable selection and regularization in order to enhance a prediction accuracy and interpretability of a statistical model. Further, sparsity refers to a matrix of numbers that include many zeros or values that will not significantly impact a calculation. In further embodiments, the ridge term is a coefficient of a multiple-regression model where independent variables are highly correlated. In particular, collinearity refers to a situation where two or more predictor variables are closely related to one another. In embodiments, the logistic loss and the penalty of the optimization function simultaneously handles mixed features (e.g., functional features, continuous features, and categorical features). In embodiments, continuous features include any value between a maximum value and a minimum value, categorical features include discrete values with each discrete value representing a category, and functional features include longitudinal data and categorical responses.

In embodiments, the optimization function is solved with an expanded version of a dual augmented lagrangian (DAL) algorithm. The DAL algorithm solves sparsity-regularized minimization problems. In embodiments, the expanded version of the DAL algorithm has a super-linear convergence rate, is highly computationally efficient in sparse scenarios, and is able to handle high-dimensional problems in which the number of features is much larger than the number of observations. Accordingly, the new version of the DAL algorithm is expanded to handle mixed features, such as functional features, continuous features, and categorical features. After the optimization module 212 performs the optimization function and identifies the most important features for a classification task, the optimization module 212 sends the selected features to the output module 214.

In embodiments, the output module 214 returns a set of selected features and estimated coefficient parameters for each of the selected features. In an example, an estimated coefficient parameter can be scalars for continuous and categorical features. In another example, an estimated coefficient parameter can be curves and surfaces for functional features. The output module 214 utilizes the estimated coefficient-parameters for each of the selected features to calculate a class probability prediction and outputs the class probability prediction.

In embodiments, the output module 214 calculates the estimated coefficient-parameters for each of the selected features and the class probability prediction based on historical data of the features and the class in a historical database. Further, the output module 214 saves the current class probability prediction and the current estimated coefficient-parameters in the historical data of the historical database. In other words, the output module 214 is configured to improve accuracy of the estimated coefficient-parameters of each of the selected features and the class probability prediction based on a model which is trained using the historical data in the historical database. Further, as the output module 214 saves more data of the estimated co-efficient parameters and class probability predictions in the historical data of the historical database, the model gets re-trained with more data. Thus, the output module 214 improves accuracy of the estimated coefficient-parameters of each of the selected features and the class probability prediction based on the model being re-trained with more data.

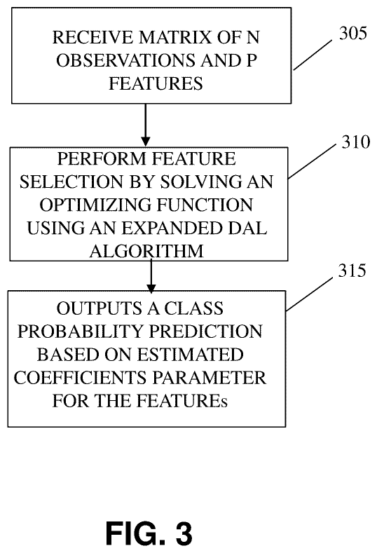

FIG. 3 shows a flowchart of an exemplary method of the adaptive feature selection server in accordance with aspects of the present invention. Steps of the method may be carried out in the environment of FIG. 2 and are described with reference to elements depicted in FIG. 2.

In embodiments, at step 305, the system receives, at the input module 210, a matrix of n observations and p features. In embodiments and as described with FIG. 2, n is an integer value which represents the last observation and p is a mixed integer feature value with represents the last mixed feature, and the number p of mixed features is much greater than the number n of observations. The input module 210 sends the matrix of n observations and p features to the optimization module 212.

At step 310, the system performs, at the optimization module 212, feature selection by performing an optimized function using an expanded dual augmented lagrangian (DAL) algorithm. In embodiments and as described with FIG. 2, the optimization module 212 performs the optimization function by minimizing an addition of a logistic loss and a penalty. In further embodiments, the minimized optimization function is solved by using the expended DAL algorithm which is able to deal with high-dimensional and mixed data (e.g., continuous data, categorical data, and functional data). At step 310, the optimization module 212 sends the selected features to the output module 214.

At step 315, the system outputs, at the output module 214, a class probability prediction based on estimated coefficient parameters for the selected features. In embodiments and described with respect to FIG. 2, the output module 214 returns the estimated coefficient parameter as a scalar for continuous and categorical features. Further, the output module 214 returns the estimated coefficient parameter as one of a curve and a surface for functional features.

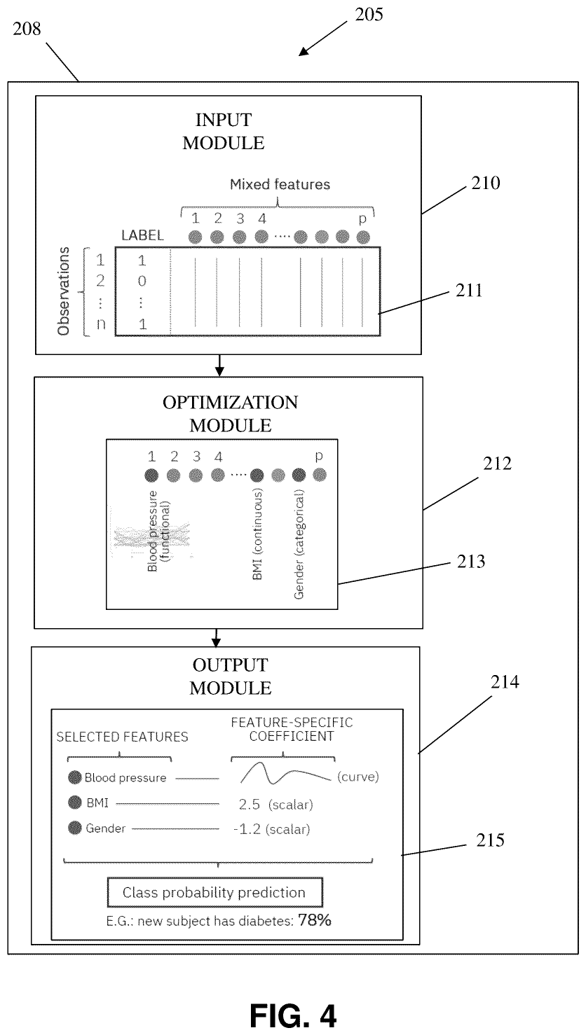

FIG. 4 shows a block diagram of an example use case performed in the environment 205 in accordance with aspects of the present invention. In particular, the exemplary environment 205 includes the input module 210, the optimization module 212, and the output module 214 as described in FIG. 2. Accordingly, details of the input module 210, the optimization 212, and the output module 214 will not be repeated in FIG. 4.

In the use case shown in FIG. 4, the input module 210 includes an example of a matrix table 211 which includes n observations on a y-axis and p features on the x-axis. The matrix table 211 also includes labels. In embodiments, each of the labels of the matrix table 211 describes a class the observation corresponds to. The optimization module 212 also includes an example of a list 213 of p features on the x-axis. As an example, the list 213 comprises blood pressure (e.g., a functional feature), a body mass index (BMI) (e.g., a continuous feature), and a gender (e.g., a categorical feature). The output module 214 includes an output 215 which includes selected features, feature-specific coefficients which correspond with the selected features, and a class probability prediction for a class. In particular, the output 215 includes the selected features of blood pressure, BMI, and gender. The output 215 also includes a curve feature-specific coefficient which corresponds with blood pressure, a scalar feature-specific coefficient in the amount of 2.5 which corresponds with BMI, and a scalar feature-specific coefficient in the amount of −1.2 which corresponds with gender. The output 215 also includes a class probability prediction based on the selected features of blood pressure, BMI, and gender and their corresponding specific coefficients. As noted herein, the output module 214 calculates the feature-specific coefficients and the class probability prediction based on the historical data in the historical database. In the output 215, the class probability prediction of 78% represents a probability of a subject having diabetes. As the class probability prediction is greater than 50%, the output 215 indicates that the subject has diabetes.

In embodiments, the adaptive feature selection server 208 is configured to be used in different scenarios. In an example, the adaptive feature selection server 208 can be used in digital health and clinical trials. For example, many clinical trials gather data from different sources, such as multiple surveys and wearable devices. In embodiments, multiple surveys are treated as categorical (e.g., gender) or continuous (e.g., BMI) features. In further embodiments, the wearable devices are treated as a functional feature (e.g., blood pressure over time). Also, the number of patients is often smaller than the number of collected variables. In this scenario with mixed data (e.g., categorical data, continuous data, and functional data), the adaptive feature selection server 208 can address several research questions, such as what are the most important features to differentiate control and treatment groups, does the treatment reduce a healthcare utilization cost, does it improve a quality of life of subjects, what are significant features to recognize people affected by a specific disease, and what is a probability that a new patient with given features has a specific disease.

In embodiments, the adaptive feature selection server 208 is configured to be used in genomic wide association studies (GWAS). In an example, many GWAS records an expression of hundreds of thousands of genes over time. In embodiments, each gene expression is represented as a function feature. The adaptive feature selection server 208 selects a small number of genes that determine a difference between two groups of patients, e.g., by identifying the genes most associated with a specific disease. However, the adaptive feature selection server 208 is not limited to these examples. In embodiments, the adaptive feature selection server 208 can be configured to classify other subjects, such as cars, toys, etc.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a matrix of a plurality of observations and a plurality of features;
performing, by the processor set, feature selection of the matrix of the plurality of observations and the plurality of features by solving an optimizing function; and
outputting, by the processor set, a class probability prediction based on estimated coefficient parameter values for selected features based on performing the feature selection of the matrix,
wherein the plurality of features are mixed and comprise categorical features, functional features, and continuous features.

2. The computer-implemented method of claim 1, wherein a number of the features is greater than a number of the observations.

3. The computer-implemented method of claim 1, further comprising solving the optimization function by minimizing a sum of a logistic loss and a penalty.

4. The computer-implemented method of claim 3, wherein the logistic loss performs classification of the features and predicts probabilities of the features belonging to a predetermined class.

5. The computer-implemented method of claim 3, wherein the penalty performs the feature selection using a plurality of terms and weights.

6. The computer-implemented method of claim 5, wherein the penalty further comprises a lasso term, a ridge term, and adaptive weights.

7. The computer-implemented method of claim 6, wherein the lasso term performs both variable feature selection and regularization.

8. The computer-implemented method of claim 6, wherein the ridge term comprises a coefficient of a multiple-regression model in which independent variables are correlated.

9. The computer-implemented method of claim 6, wherein the adaptive weights are used to perform the feature selection and predictive performance.

10. The computer-implemented method of claim 1, further comprising solving the optimizing function using an expanded dual augmented lagrangian (DAL) algorithm.

11. The computer-implemented method of claim 1, wherein the continuous features include any value between a maximum value and a minimum value, the categorical features include discrete values with each discrete value representing a category, and the functional features include longitudinal data and categorical responses.

12. A computer program product comprising one or more computer readable storage media having program instructions collectively stored on the one or more computer readable storage media, the program instructions executable to:
receive a matrix of a plurality of observations and a plurality of features;
perform feature selection of the matrix of the plurality of observations and the plurality of features by solving an optimizing function; and
output a class probability prediction based on estimated coefficient parameter values for selected features based on performing the feature selection of the matrix,
wherein the plurality of features are mixed and comprise categorical features, functional features, and continuous features.

13. The computer program product of claim 12, wherein a number of the features is greater than a number of the observations.

14. The computer program product of claim 12, further comprising solving the optimizing function by minimizing a sum of a logistic loss and a penalty.

15. The computer program product of claim 14, wherein the logistic loss performs classification of the features and predicts probabilities of the features belonging to a predetermined class.

16. The computer program product of claim 14, wherein the penalty performs the feature selection using a plurality of terms and weights.

17. The computer program product of claim 12, further comprising solving the optimization function by using an expanded dual augmented lagrangian (DAL) algorithm.

18. The computer program product of claim 12, wherein the continuous features include any value between a maximum value and a minimum value, the categorical features include discrete values with each discrete value representing a category, and the functional features include longitudinal data and categorical responses

19. A system comprising:
a processor set, one or more computer readable storage media, and program instructions collectively stored on the one or more computer readable storage media, the program instructions executable to:
receive a matrix of a plurality of observations and a plurality of features;
perform feature selection of the matrix of the plurality of observations and the plurality of features by solving an optimizing function; and
output a class probability prediction based on estimated coefficient parameter values for selected features based on performing the feature selection of the matrix,
wherein the plurality of features are mixed and comprise categorical features, functional features, and continuous features.

20. The system of claim 19, further comprising solving the optimizing function using an expanded dual augmented lagrangian (DAL) algorithm.
